(19) United States
(12) Patent Application Publication
(10) Pub. No.: US 2004/0112718 A1
(43) Pub. Date: Jun. 17, 2004

(54) Fastening apparatus for detachable securement of a motor to a conveyor

(75) Inventors: Wolfgang Brixius, Neunkirchen (DE); Dominik Grafer, Nurnberg (DE); Albrecht Hoene, Herzogenaurach (DE)

Correspondence Address: Henry M. Feiereisen, Suite 4714, 350 Fifth Avenue, New York, NY, 10118, US

(73) Assignee: SIEMENS AKTIENGESELLSCHAFT, MUNCHEN (DE)

(21) Appl. No.: 10/667,147

(22) Filed: Sep. 19, 2003

(30) Foreign Application Priority Data
Sep. 20, 2002 (DE) 10243920.6

(51) Int. Cl. B65G 23/22

(52) U.S. Cl. 198/788

(57) ABSTRACT

Apparatus for detachable securement of a motor to an attachment member of a conveyor, includes a pair of connector elements, with one connector element fastened to the motor and the other connector element fastened to the attachment member. The connector elements define a bayonet coupling which includes a bayonet element projecting out of one of the connector elements for reception in an opening of the other one of the connector elements. The bayonet coupling is constructed with an inclined surface to effect a movement of the connector elements toward one another in axial direction as the connector elements are turned and/or shift relative to one another. A securing element is provided for safeguarding the connector elements against detachment, when the connector elements are secured to one another.

### CROSS-REFERENCES TO RELATED APPLICATIONS

This application claims the priority of German Patent Application, Serial No. 102 43 920.6, filed Sep. 20, 2002, pursuant to 35 U.S.C. 119(a)-(d), the disclosure of which is incorporated herein by reference.

### BACKGROUND OF THE INVENTION

The present invention relates to a fastening apparatus for detachable securement a motor, in particular a drive motor, to a conveyor.

Typically, a conveyor includes for driving purposes an electric motor which is oftentimes screwed with its end surface to a connecting flange of the framework of the conveyor. The motor shaft juts out from the end surface to extend through a central opening in the connecting flange for connection to a driveshaft. During operation of the conveyor, the motor operates the driveshaft which in turn transmits the rotary motion via a transmission to the conveyor.

A dismantling of a defective motor, for example, requires a disconnection and separation from the driveshaft, and a loosening of the screws, by which the motor is fastened to the connecting flange. A new motor is installed by executing these steps in reverse order. This procedure is time-consuming and results in downtimes of the conveyor.

It would therefore be desirable and advantageous to provide an improved fastening apparatus for detachable securement of a motor to a conveyor to obviate prior art shortcomings.

### SUMMARY OF THE INVENTION

According to one aspect of the present invention, an apparatus for detachable securement of a motor to an attachment member of a conveyor, includes a fastening assembly for securing an output side of the motor to the attachment member, wherein the fastening assembly includes a pair of connector elements, with one connector element fastened to an end surface of the motor and the other connector element fastened to the attachment member, wherein the connector elements are configured to define a bayonet coupling for detachable interconnection thereof and have aligned throughbores for passage of a motor shaft of the motor, when the connector elements adjoin one another in a receiving position and are secured to one another in an end position via the bayonet coupling, as the connector elements are turned and/or shifted relative to one another, wherein the bayonet coupling includes a bayonet element projecting out of one of the connector elements for reception in an opening of the other one of the connector elements, with the bayonet coupling constructed to have an inclined surface to effect a movement of the connector elements toward one another in axial direction as the connector elements are turned and/or shifted relative to one another, and a securing unit for safeguarding the connector elements against detachment, when the connector elements are secured to one another.

A fastening apparatus in accordance with the present invention enable as rapid mounting of the motor to a conveyor whereby a high torque can be transmitted as a consequence of the realized intimate pre-tensioned friction and form-fitting engagements. The connector elements can be made available pre-assembled with the motor and the attachment member, respectively, so that the securement of the motor to the conveyor can be implemented by simply moving the motor in axial direction toward the attachment member and then turning it in circumferential direction. Through the intervention of the bayonet coupling between the attachment member and the motor, a single turning motion is sufficient to secure the motor to the conveyor. As a result, assembly times and dismantling times are considerably decreased. Hereby, the motor is centered in relation to the attachment member, and the motor shaft is centered in relation to the driveshaft because the connector elements define the position of the motor with respect to the attachment member.

According to another feature of the present invention, one of the connector elements has a plurality of such bayonet elements, and the other one of the connector elements has a plurality of such openings, wherein the bayonet elements of one connector element can engage behind the openings of the other connector element.

According to another feature of the present invention, the bayonet element may include a stem portion, which is disposed in parallel relationship to the motor shaft and has a free end, and a head portion, which is disposed on the free end of the stem portion and has a cross section which extends beyond the stem portion in transverse direction.

Joining of both connector elements can be simplified, when each bayonet element of the bayonet coupling is constructed to effect a movement of the connector elements toward one another in axial direction, as the connector elements are turned and/or shifted to the end position. An initially existent play in the receiving position enables an easy turning and/or shifting of both connector elements, even when both connector elements slantingly abut one another slightly. A gap existent between the connector elements is progressively decreased and ultimately closed, as the connector elements are turned and/or shifted.

The provision of such a play or gap may be realized in accordance with another feature of the present invention, by constructing the head-proximal side of the other connector element with a slanted configuration in order to define the inclined surface of the bayonet coupling so as to enable the connector elements to move toward one another in axial direction as the connector elements are turned and/or shifted relative to one another. Suitably, the other connector element may be formed with an engagement zone in an area adjacent to the opening, whereby the engagement zones has a ridge, which extends in circumferential direction and cooperates with the bayonet element. The ridge may have a tapered configuration in the direction of the opening to define the inclined surface of the bayonet coupling. Another option may involve in addition a construction in which the head portion has an underside in confronting relationship to the stem portion, which underside may be constructed in slanted configuration in direction of turning and/or shifting to define the inclined surface of the bayonet coupling.

According to another feature of the present invention, the securing assembly may include a first flange, which is connected to an outer circumference of one connector element, a second flange, which is connected to an outer circumference of the other connector element, and a securing element for coupling the first and second flanges, when the connector elements assume the end position, to thereby restrain the connector elements against rotation and/or displacement. The flanges of the connector elements may abut one another in the end position, or may be positioned at a distance to one another in the end position. Thus, a tilting of the motor shaft relative to the driveshaft of the transmission is prevented in this way in a simple manner.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is an exploded illustration of a fastening apparatus in accordance with the present invention for securing a motor to an attachment;

FIG. 2 is a perspective illustration, on an enlarged scale, of one connector element of the fastening apparatus;

FIG. 3 is a perspective illustration, on an enlarged scale, of another connector element of the fastening apparatus;

FIG. 4 is a perspective illustration of finished connection of the motor to the attachment via the fastening apparatus;

FIG. 5 is a sectional view of the finished connection, taken along the line V-V in FIG. 4;

FIG. 6 is a cutaway view, on an enlarged scale, of the other connector element, showing in detail the area of a receiving opening;

FIG. 7 is a cutaway plan view, on an enlarged scale, of a bayonet coupling in the area of the receiving opening; and

FIG. 8 is a cutaway plan view, on an enlarged scale, of a variation of a bayonet coupling in the area of the receiving opening.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

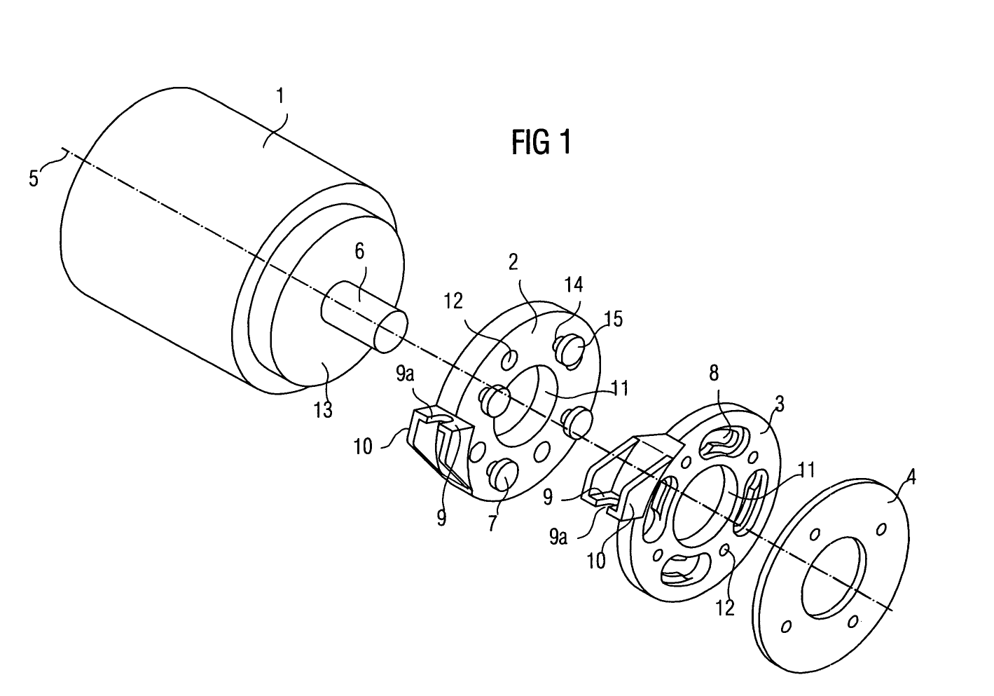

Turning now to the drawing, and in particular to FIG. 1, there is shown an exploded illustration of a fastening apparatus in accordance with the present invention for securing the output of a motor 1 to an attachment member 4 which forms part of a conveyor and may, for example, be mounted to a framework of the conveyor. For sake of simplicity, more details of the conveyor have been omitted from the Figures as they are not part of the invention. The motor 1 has an end surface 13 and a motor shaft 6 which juts out from the end surface 13 and rotates about a rotation axis 5.

The fastening apparatus according to the invention includes two disk-shaped connector elements 2, 3 which are coupled by a bayonet coupling and positioned between the motor 1 and the attachment member 4 for securing the motor 1 to the attachment member 4. The connector element 2 has a central throughbore 11 and is formed with four spaced-apart bores 12 about its circumference for receiving screws (not shown) so as to mount the connector element 2 to the end surface 13 of the motor 1, with the motor shaft 6 extending through the throughbore 11. The connector element 2 can thus be shipped preassembled with the motor 1. Likewise, the connector element 3 has a central throughbore 11 and is formed with four spaced-apart bores 12 about its circumference for receiving screws (not shown) so as to mount the connector element 3 to the attachment member 4 of the conveyor. The connector element 3 can thus be shipped preassembled with the attachment member 4.

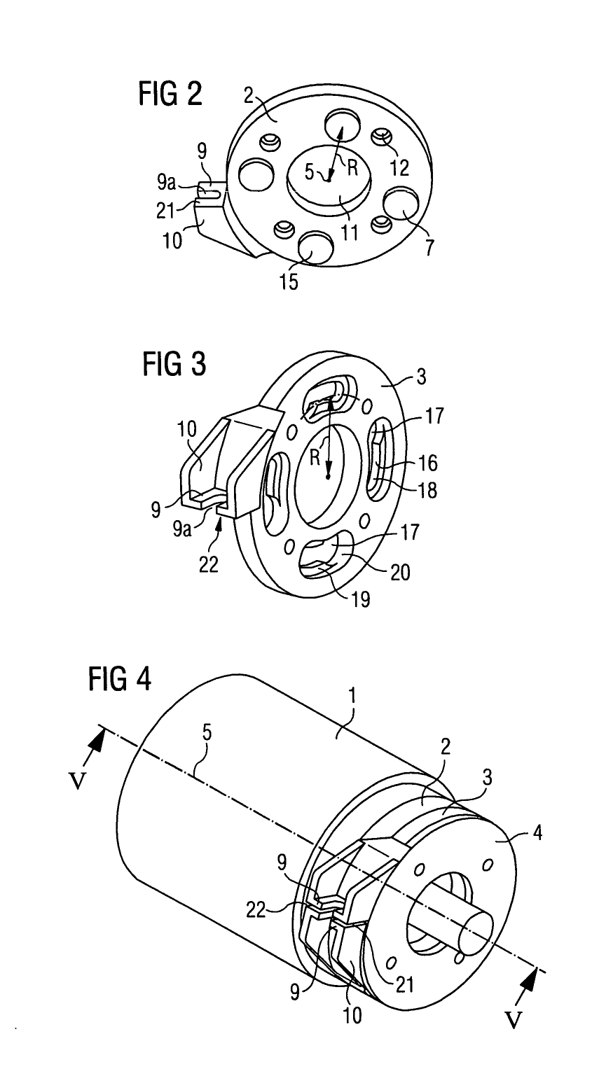

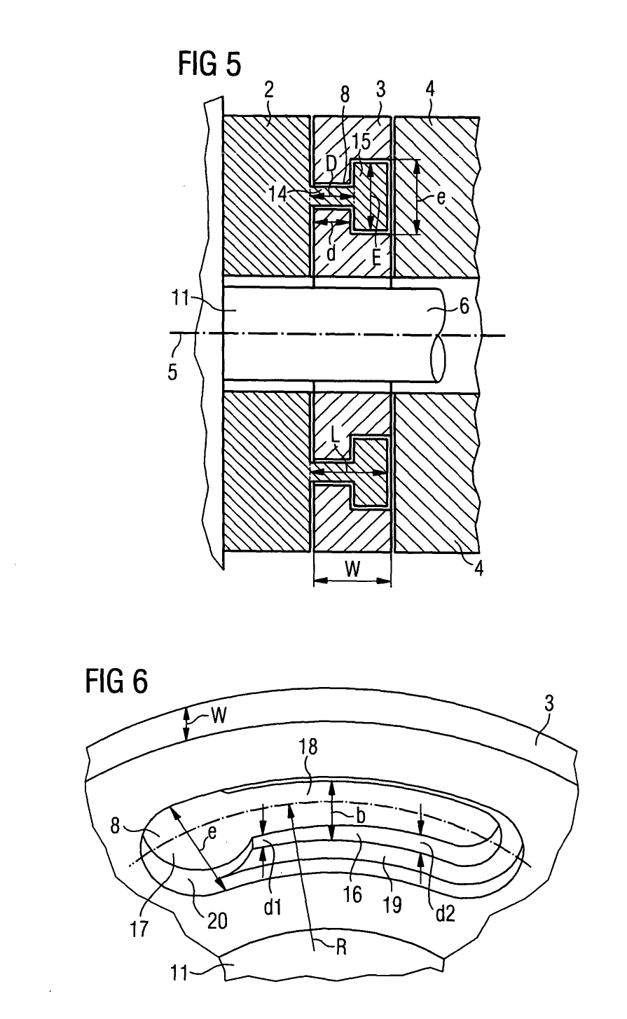

Referring now to FIG. 2, there is shown a perspective illustration, on an enlarged scale, of the connector element 2 of the fastening apparatus. The connector element 2 is formed with four bayonet elements 7 disposed in coaxial relationship to the rotation axis 5 and spaced from one another at a same angular distance. Each bayonet element 7 is spaced from the rotation axis 5 at a same radial distance R and includes a cylindrical stem portion 14 which extends out from the connector element 2 and terminates in a free end in the form of a head portion 15. The head portion 15 has a diameter E (FIG. 5) which is greater than a diameter of the stem portion 14.

The bores 12 are respectively arranged between the bayonet elements 7 also in coaxial relationship to the rotation axis 5 and at a same angular distance. Extending radially from the outer perimeter of the connector element 2 is a flange 9 which has an attachment surface 21 and a slotted groove 9a. On the side facing away from the attachment surface 21, the flange 9 is supported against the outer perimeter of the connector element 2 by stays 10.

FIG. 3 shows a perspective illustration, on an enlarged scale, of the connector element 3 of the fastening apparatus, illustrating the side facing away from the connector element 2. Parts corresponding with those in FIG. 2 are generally denoted by identical reference numerals. The connector element 3 is formed with four identical receiving openings 8 configured as oblong holes. The receiving openings 8 are disposed in coaxial relationship to the rotation axis 5 and spaced from one another at a same angular distance. The bores 12 are respectively arranged between the openings 8, also in coaxial relationship to the rotation axis 5 and at a same angular distance. Extending radially from the outer perimeter of the connector element 3 is also a flange 9 which has an attachment surface 22 and a slotted groove 9a. On the side facing away from the attachment surface 22, the flange 9 is supported against the outer perimeter of the connector element 3 by stays 10.

Like the bayonet elements 7 of the connector element 2, the receiving openings 8 are arranged on the connector element 3 at a same radial distance R from the rotation axis 5. The receiving openings 8 are curved about the rotation axis 5 and include on one end a circular insert slot 17 with a diameter “e”, as shown in FIG. 5. All receiving openings 8 have hereby their insert slots 17 at a forward location, as viewed in circumferential direction. Adjoining the insert slot 17, the receiving opening 8 includes an engagement zone 18 which extends in circumferential direction from the insert slot 17 to the other end of the receiving opening 18, whereby the engagement zone 18 has a constant width in correspondence to the diameter “e” of the insert slot 17. Arranged in the engagement zone 18 along the inside surface 20 of the receiving opening 8 is a radial ridge 16 with a side wall as undercut to reduce the receiving opening 19 in size to a width “b” (see FIG. 6.)

The securement of the motor 1 to the conveyor is realized by positioning the pre-assembled connector elements 2, 3 in such a way that the bayonet elements 7 are placed in opposition to the insert slots 17 of the receiving openings 8. Subsequently, the motor 1 is moved in axial direction against the connector element 3 until both connector elements 2, 3 abut one another to assume their receiving position and the bayonet elements 7 project into the insert slots 17. By turning the motor 1 clockwise, an end position is realized in which each of the head portions 15 of the bayonet element 7 engages behind the ridge 16 in the receiving openings 8 so as to secure the motor 1 to the conveyor. As shown in particular in FIG. 4, in the end position, the attachment surfaces 21, 22 of the flanges 9 of the connector elements 2, 3 confront one another, thereby permitting a securing element in the form of a thumbscrew (not shown) to extend through the aligned grooves 9a and thus to interconnect the flanges 9. In this way, the connector elements 2, 3 are secured and, as a consequence, the motor 1 is mounted to the conveyor and restrained against rotation and detachment.

Disassembly of the motor 1 is realized in a same manner, only in reverse order.

FIG. 5 shows by way of a section illustration the securement of the motor 1 to the attachment 4 via the connector elements 2, 3. Both connector elements 2, 3 are non-rotatably fixed in their end position with one another, with the head portion 15 of the bayonet elements 7 of the connector element 2 engaging behind the ridge 16 of the receiving openings 8 of the connector element 3 to thereby interlock both connector elements 2, 3. The side wall 19 of the ridge 16 serves hereby as contact surface for the stem portion 14 of the head portion 15.

As further shown in FIG. 5, the connector element 3 has a wall thickness W which, in axial direction of the motor shaft 6, is dimensioned equal or greater than a length L of the bayonet element 7.

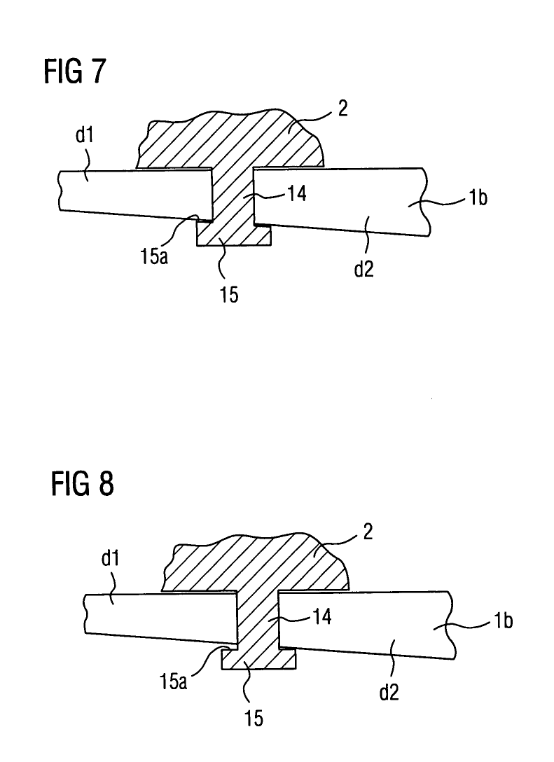

FIG. 6 shows a perspective illustration of a sector-like area of a variation of the connector element 3. Parts corresponding with those in FIG. 3 are denoted by identical reference numerals and not explained again. In this embodiment, provision is made for a receiving opening 8 which has also an elongate configuration and is curved with a radius R, with a circular insert slot 17 at one end thereof (here the left-hand side. The diameter “e” of the insert slot 17 corresponds hereby substantially to the diameter E of the head portion 15 to allow insertion of the bayonet element 7. The engagement zone 18 adjoining the insert slot 17 extends also over the remaining length of the receiving opening 8 and accommodates the ridge 16 to reduce the receiving opening 8 to a width “b” in correspondence to the diameter of the stem portion 14. The ridge 16 has in immediate proximity of the insert slot 17 a wall thickness d₁ which is so selected that the projecting head portion 15 of the bayonet element 7 engages the ridge 16 with clearance, as shown in particular in FIGS. 7 and 8. In other words, the wall thickness d₁ of the ridge 16 is smaller than the length D of the stem portion 14 of the bayonet element 7. At the other end of the receiving opening 8, the ridge 16 has a wall thickness d₂ which corresponds precisely to the length D of the stem portion 14. Thus, the ridge 16 in each receiving opening 8 of the connector element 3 of FIG. 3 widens in turning direction so that during turning of the connector element 2 clockwise or relative turning of the connector elements 2, 3 into the end position, both connector elements 2, 3 are pulled together in axial direction. A gap encountered between both connector elements 2, 3 in the receiving position is thereby closed during turning into the end position.

FIG. 7 shows a configuration of the bayonet coupling in which the head portion 15 has an underside 15a in facing relationship to the stem portion 14, whereby the underside 15a is slanted in direction of turning and/or shifting in substantial parallel relationship to the tapered configuration of the confronting surface of the ridge 16. FIG. 8 shows a configuration of the bayonet coupling in which only the ridge 16 has the tapered or inclined shape while the underside 15a of the head portion 15 is straight.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. Apparatus for detachable securement of a motor to an attachment member of a conveyor, comprising:
fastening means for securing an output side of the motor to the attachment member, said fastening means including a pair of connector elements, with one connector element fastened to an end surface of the motor and the other connector element fastened to the attachment member, said connector elements configured to define a bayonet coupling for detachable interconnection thereof and having aligned throughbores for passage of a motor shaft of the motor, when the connector elements adjoin one another in a receiving position and are secured to one another in an end position via the bayonet coupling, as the connector elements are turned and/or shifted relative to one another, wherein the bayonet coupling includes a bayonet element projecting out of one of the connector elements for reception in an opening of the other one of the connector elements, said bayonet coupling being constructed with an inclined surface to effect a movement of the connector elements toward one another in axial direction as the connector elements are turned and/or shift relative to one another; and
securing means for safeguarding the connector elements against detachment, when the connector elements are secured to one another.

2. The apparatus of claim 1, wherein the one of the connector elements has a plurality of said bayonet element, and the other one of the connector elements has a plurality of said opening, whereby the plurality of bayonet elements and the plurality of openings are placed in one-to-one correspondence, wherein the bayonet elements of one connector element engage behind the openings of the other connector element.

3. The apparatus of claim 1, wherein the bayonet element includes a stem portion, which is disposed in parallel relationship to the motor shaft and has a free end, and a head portion, which is disposed on the free end of the pin and has a cross section which extends beyond the stem portion in transverse direction.

4. The apparatus of claim 3, wherein the head portion has an underside in confronting relationship to the stem portion, said underside being slanted in direction of turning and/or shifting to define the inclined surface of the bayonet coupling.

5. The apparatus of claim 3, wherein the other connector element has a head-proximal side which is slanted to define the inclined surface of the bayonet coupling to enable the connector elements to move toward one another in axial direction as the connector elements are turned and/or shifted relative to one another.

6. The apparatus of claim 1, wherein said securing means includes a first flange connected to an outer circumference of one connector element, a second flange connected to an outer circumference of the other connector element, and a securing element for coupling the first and second flanges, when the connector elements assume the end position, to thereby restrain the connector elements against rotation and/or displacement.

7. The apparatus of claim 6, wherein the flanges of the connector elements abut one another in the end position.

8. The apparatus of claim 6, wherein the flanges of the connector elements are positioned at a distance to one another in the end position.

9. The apparatus of claim 6, wherein the securing element is a fastening screw.

10. The apparatus of claim 9, wherein the securing element is a thumbscrew.

11. The apparatus of claim 3, wherein the head portion has a diameter which exceeds a diameter of the stem portion.

12. The apparatus of claim 1, wherein the other connector element is formed with an engagement zones in an area adjacent to the opening, said engagement zones having a ridge extending in circumferential direction and cooperating with the bayonet element.

13. The apparatus of claim 12, wherein the ridge have a tapered configuration in the direction of the opening to define the inclined surface of the bayonet coupling.
